(19) United States
(12) Patent Application Publication
(10) Pub. No.: US 2007/0297609 A1
(43) Pub. Date: Dec. 27, 2007

(54) Secure Wireless HeartBeat

(75) Inventors: Neil Adams, Waterloo (CA); Herbert Little, Waterloo (CA)

Correspondence Address: INTEGRAL INTELLECTUAL PROPERTY INC., 1370 DON MILLS ROAD, SUITE 300, TORONTO, ON, M3B 3N7, US

(73) Assignee: Research In Motion Limited, Waterloo (CA)

(21) Appl. No.: 11/426,043

(22) Filed: Jun. 23, 2006

(51) Int. Cl. H04K 1/00

(52) U.S. Cl. 380/270; 380/273

(57) ABSTRACT

A wireless communications link may be made more secure by imposing additional security measures at the application level to create a secure channel. These measures are compatible with and transparent to any security measures which are applied at the link level. A secure keep-alive heartbeat may be created on the secure channel to ensure that both devices are within range and able to communicate throughout the connection.

### BACKGROUND

Wireless technology provides an easy way for a wide range of devices to communicate with each other and connect to the Internet without the need for wires, cables and connectors. Wireless technology is increasingly taking the place of direct communications links between personal computers and peripheral devices, such as printers and keyboards, and wired local area networks (LAN) are being replaced with wireless LANs in office and industrial settings.

For example, Bluetooth® is an industrial standard for short-range wireless communications using radio frequency (RF) data transmission. Bluetooth® technology uses the portion of the RF spectrum near 2.4 GHz frequency that is reserved for industrial, scientific and medical devices. Bluetooth®-enabled devices are able to communicate without wires over an air-interface of up to 100 feet.

When a communication session between two wireless devices has been established, a low level “keep-alive heartbeat” may be established between the two devices to verify that both devices are still present and within range throughout the session. The heartbeat consists of a periodic check in which one side of the connection queries the other side at regular intervals. If there is no acknowledgement response from the second device within a predetermined time interval (the timeout period), the first device will drop the connection with the second device. In like manner, if the second device does not receive a query within a predetermined time interval, it will drop the connection with the first device.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic diagram of an exemplary system involving a wireless-enabled smart card reader, according to some embodiments of the invention;

FIG. 2 is a flowchart showing an exemplary method for creating a secure wireless heartbeat;

FIG. 3A is a flowchart of an exemplary method to be implemented by a device receiving a secure heartbeat;

FIG. 3B is a flowchart of an exemplary method to be implemented by a device sending a secure heartbeat;

FIG. 4 is a schematic diagram showing an exemplary command packet used for sending a heartbeat command on the secure channel; and

FIG. 5 is a block diagram of an exemplary system, according to some embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the embodiments of the invention.

Wireless communications between devices are particularly susceptible to attacks on the security of the connection. Several broad classes of such attacks exist: (1) a disclosure threat involves the leakage of information from the system to a party that should not have seen the information and it is a threat against the confidentiality of the information. (2) an integrity threat involves an unauthorized change of the information in question. (3) a denial of service threat involves an access to a system resource being blocked by a malicious attacker. Wireless standards may provide for security measures designed to address these threats. For example, the Bluetooth® standard includes unique Bluetooth® addresses to identify each device, and the use of device authentication and encryption keys. In the most secure mode of operation, Bluetooth® Security Mode 3, security controls such as device authentication and encryption are applied at the baseband level before a channel is established between devices.

While these security measures may be considered adequate for some applications, they are typically not considered reliable for particularly security-sensitive tasks such as those involving money-transfers, or confidential government communications. The Bluetooth® authentication algorithms can only authenticate devices, not users, for example. However, the Bluetooth® security architecture also allows applications to enforce their own security policies. The link layer, at which the Bluetooth® security measures operate, is transparent to the security controls imposed by the application. To enhance the security of a standard Bluetooth® connection, an additional layer of security measures, including for example, additional encryption using advanced encryption algorithms, or user authentication measures, may be imposed at the application level to create a secure channel between devices. Although the “Advanced Encryption Standard (AES)” developed by Joan Daemen and Vincent Rijmen is an example of an algorithm that can be used in the additional layer of security measures, other algorithms could be used instead or additionally, and the phrase “advanced encryption” is intended to comprise both AES and the other algorithms.

Keys for the advanced encryption are stored in the devices and may be cleared from one or the other of the devices in the event that the connection between the devices is lost. Likewise, the keys may be cleared if the transmit power required to maintain the connection exceeds a predetermined limit. In some devices, the keys are stored in the clear, for example, in the device's random access memory (RAM). In such cases, it is important to clear the keys at the end of a communication session, and force new encryption keys to be generated for all subsequent communication sessions between the devices.

The standard link-level keep alive heartbeat provided by the Bluetooth® standard is relatively susceptible to attacks. In one mode of attack, a third party to the connection could steal one of the devices, and keep the connection to the other device alive by creating their own heartbeat. The attacker may then intercept the communications, or may use the connection to access data stored on the other device. If a key is stored unencrypted on the stolen device, the attacker could probe the stolen device for the key. Since the connection is being kept alive by the fake heartbeat, the key will not have been cleared. An attacker could also use the link-level heartbeat to circumvent the constraint on distance between the devices due to the maximum allowable power range. An attacker could keep the fake heartbeat close to the device to trick the device into thinking that the stolen device is closer than it really is. An attacker could also use the link-level heartbeat to keep one or both of the devices unlocked. One or both of the devices may be configured to lock once the connection is dropped. By keeping the connection alive, the devices remain unlocked when they should not be.

To further enhance the security of a connection between two Bluetooth® devices, the standard link-level keep-alive heartbeat may be supplemented by an additional heartbeat that is communicated on the secure channel. This additional heartbeat is called the “secure heartbeat” in this description. Since the secure heartbeat is communicated on a secure wireless channel, it is less susceptible to the attacks described above. It would be very difficult for an attacker to spoof the secure heartbeat.

A user of the device can specify whether the secure heartbeat should be used using a configuration interface on the device. The user can also specify any additional parameters associated with the secure heartbeat such as timeout periods, which are discussed below in further detail. Alternatively, a network administrator can enforce the use of the secure heartbeat and can define the various additional parameters that are required to ensure that the secure heartbeat provides the required level of susceptibility to security attacks.

An example application where enhanced security is important is one in which an authentication device such as a smart card reader communicates wirelessly with a protected device (such as a personal computer or PDA) to limit access to the protected device. Typically, smart card readers communicate with protected devices using a direct connection. However, a smart card reader that communicates with a protected device using a wireless communication protocol such as Bluetooth® (BT) has recently been proposed. When the communication between the smart card reader and the protected device is wireless, it is particularly important to secure this communication in order to protect the personal information stored on the smart card and the information on the protected device.

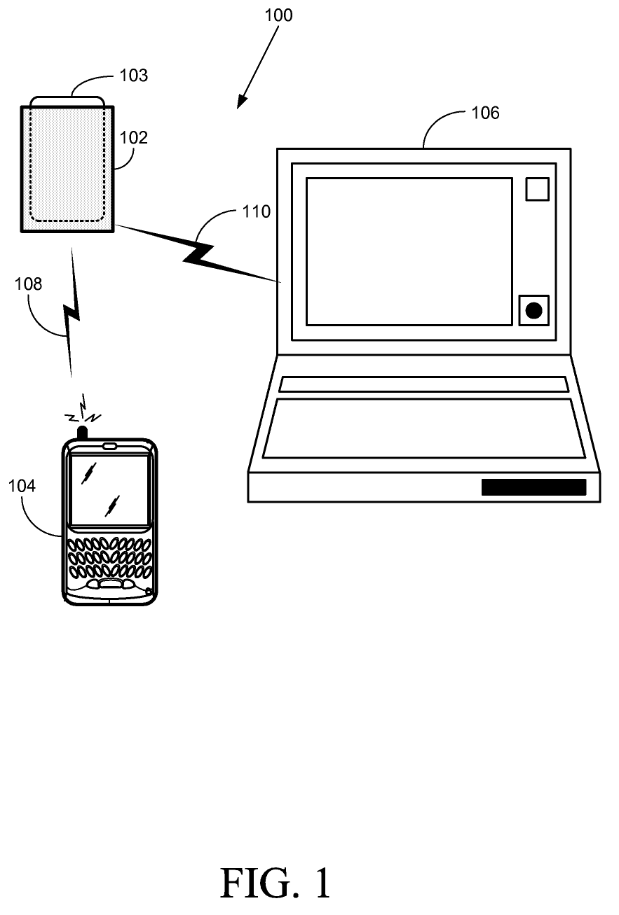

FIG. 1 is a schematic diagram of an exemplary system including a wireless-enabled smart card reader, according to some embodiments of the invention. A system 100 includes a wireless-enabled smart card reader (SCR) 102, and a wireless-enabled mobile device 104, and a wireless-enabled personal computer 106. A smart card (SC) 103 is shown inserted into smart card reader 102. Mobile device 104 and personal computer 106 are examples of devices that may be protected using an authentication device such as smart card reader 102 and smart card 103.

Smart card reader 102 and mobile device 104 may communicate via a Bluetooth® wireless communication link 108, and smart card reader 102 and personal computer 106 may communicate via a Bluetooth® wireless communication link 110. Alternatively, communication links 108 and 110 may be compatible with other wireless communication standards, including for example, the Zigbee™ standard, the ultra wideband standard (UWB) and the like.

Smart cards are personalized security devices, defined by the ISO 7816 standard and its derivatives, as published by the International Standards Organization. A smart card may have a form factor of a credit card and may include a semiconductor device. The semiconductor device may include a memory that can be programmed with security information (e.g. a private decryption key, a private signing key, biometrics, an authentication certificate, etc.), and may include a decryption engine, e.g. a processor and/or dedicated logic, for example, dedicated decryption logic and/or dedicated signing logic. The smart card may require that a password or personal identification number (PIN) be supplied before the security information and the decryption and signing functions can be accessed. A smart card may include a connector for powering the semiconductor device and performing serial communication with an external device. Alternatively, smart card functionality may be embedded in a device having a different form factor and different communication protocol, for example a Universal Serial Bus (USB) device. A smart card may be used for visual identification, time cards, door access, and the like.

The person whose security information is stored on smart card 103 may use smart card reader 102, for example, to provide personal identification from smart card 103 to mobile device 104 or personal computer 106 for authentication and access to the devices, or to digitally sign and/or decrypt e-mail messages sent by mobile device 104 or personal computer 106. For these applications, the administrator may closely circumscribe the power range of communications between the smart card reader and the protected device in order to restrict access to the smart card reader by unauthorized persons.

A non-exhaustive list of examples for mobile device 104 includes any of the following wireless computerized devices, for example, notebook computers, laptop computers, desktop personal computers, personal digital assistants (PDAs), handheld computers, cellular telephones, MP3 players, and the like.

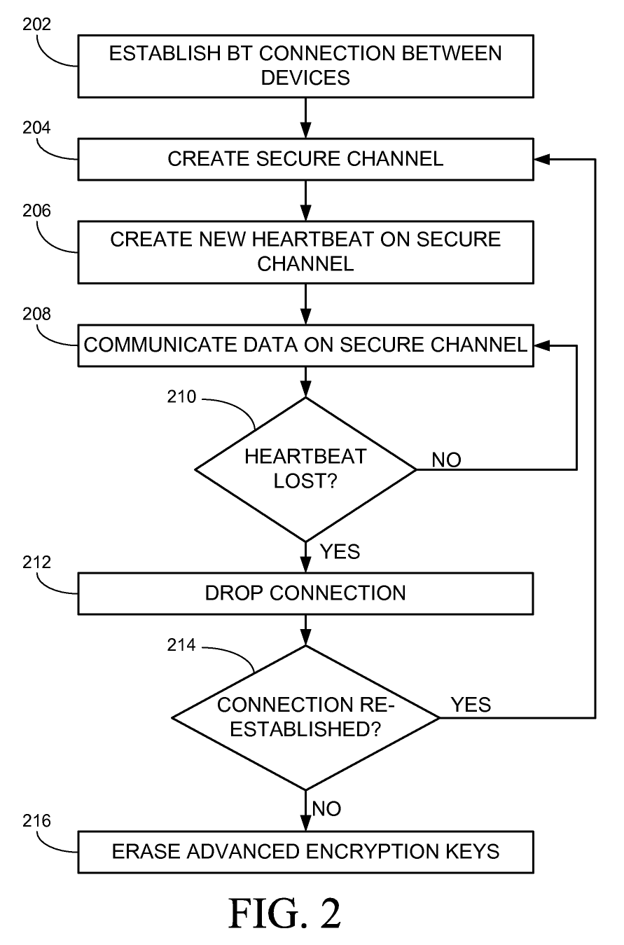

FIG. 2 is a flowchart showing an exemplary method for creating a secure heartbeat compatible with the system shown in FIG. 1. At 202, a BT connection is established between two devices, for example, SCR 102 and mobile device 104, or SCR 102 and personal computer 106. Any level of BT security may be used for the connection, because the BT security measures are imposed at the link level and are transparent to the application-level security. At 204, a secure channel is created by imposing additional security measures, for example, advanced encryption techniques, at the application level. Each of the two devices stores the keys used for the advanced encryption. The keys may be stored encrypted, or transparently.

For example, the establishment of the secure channel may involve the following steps. After the two devices have completed the secure pairing, they will each hold a 256-bit session key V. This key is used to initialize the secure channel. During initialization, four keys are derived by using SHA-256 to hash V along with a predetermined string. The string varies for each of the four keys. The four keys are used to encrypt, decrypt, and authenticate the messages sent between the two devices. The secure channel uses AES-256 in CBC mode for encryption and decryption. The secure channel uses HMAC-SHA-256 to compute the message authentication code (MAC). This MAC is then encrypted along with the message. Each encrypted message contains a message counter. One copy of the message counter is left unencrypted at the beginning of the message and one copy is encrypted. Consequently, one can identify whether the message has been tampered with. A new secure channel is established once the counter reaches 2⁶⁴−1.

At 206, a new heartbeat is created on the secure channel by sending “secure heartbeat” command packets at regular intervals. The interval between individual heartbeat command packets, a heartbeat lost timeout period, and a heartbeat response lost timeout period may be defined by the user or network administrator, or may be determined by the manufacturer. Typically, the heartbeat response lost timeout period is significantly shorter than the heartbeat lost timeout period. At 208, the two devices begin transmitting and receiving data on the secure channel. If at any time during the communication the heartbeat is lost (210), i.e., the first device does not receive a heartbeat response command packet from the second device within the heartbeat response lost timeout period, or the second device does not receive an expected heartbeat command packet from the first device within the heartbeat lost timeout period, then, at 212, the connection is dropped.

Another timeout period, a connection dropped timeout period, may also be defined. During the connection dropped timeout period, the user has an opportunity at 214 to reconnect the devices using the existing advanced encryption keys. If the devices are not reconnected within the connection dropped timeout, the advanced encryption keys are cleared from both devices at 216, and new advanced encryption keys will need to be generated for any subsequent communication sessions between the devices.

While the method of FIG. 2 has been described for a BT connection, it will be obvious to those skilled in the art how to modify it for use with other wireless protocols, including the Zigbee™ standard, the ultra wideband standard (UWB) and the like.

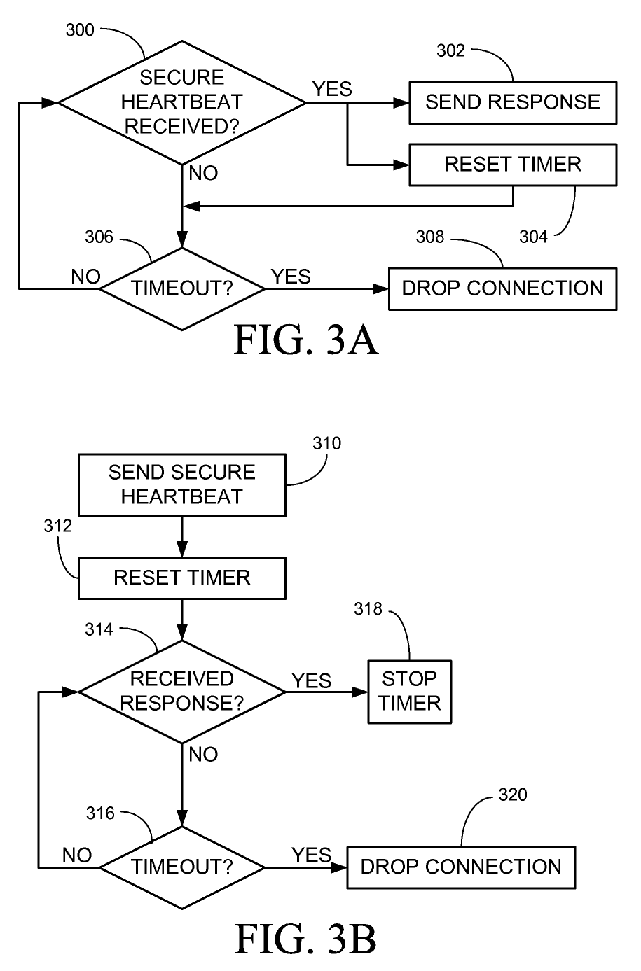

FIGS. 3A and 3B provide more detail regarding the secure heartbeat. FIG. 3A is a flowchart of an exemplary method to be implemented by the device receiving the secure heartbeat, for example, SCR 102. At 300, the device checks whether a secure heartbeat has been received. The method loops until either a secure heartbeat is received or a timeout expires. If a secure heartbeat is received (checked at 300), then the device sends a response at 302 and resets the timer at 304. If the timeout expires (checked at 306), then the device drops the connection at 308. The timeout expires if the heartbeat lost timeout period has elapsed since the most recent secure heartbeat was received.

FIG. 3B is a flowchart of an exemplary method to be implemented by the device sending the secure heartbeat, for example, mobile device 104 or personal computer 106. The device sends the secure heartbeat at 310 and resets the timer at 312. If a response to the secure heartbeat has been received (checked at 314) before a timeout expires (checked at 316), then the timer is stopped at 318. If the timeout expires without the device having received a response to the secure heartbeat, then the device drops the connection at 320. The timeout expires if the heartbeat response lost timeout period has elapsed since the most recent secure heartbeat was sent. For example, the heartbeat response lost timeout period may be set to the time it takes for a command to be sent from this device to the other device and for the other device to respond, plus some extra time for each device to process the command or response. If a device does garbage collection, this extra time may be as much as 30 seconds.

Computer-executable instructions for creating a secure keep-alive heartbeat according to the above-described method may be stored on a form of computer readable media. Computer readable media includes volatile and nonvolatile, removable and non-removable media implemented in any method or technology for storage of information such as computer readable instructions, data structures, program modules or other data. Computer readable media includes, but is not limited to, random access memory (RAM), read-only memory (ROM), electrically erasable programmable ROM (EEPROM), flash memory or other memory technology, compact disk ROM (CD-ROM), digital versatile disks (DVD) or other optical storage, magnetic cassettes, magnetic tape, magnetic disk storage or other magnetic storage devices, or any other medium which can be used to store the desired instructions and which can be accessed by a computing device, including by internet or other computer network forms of access.

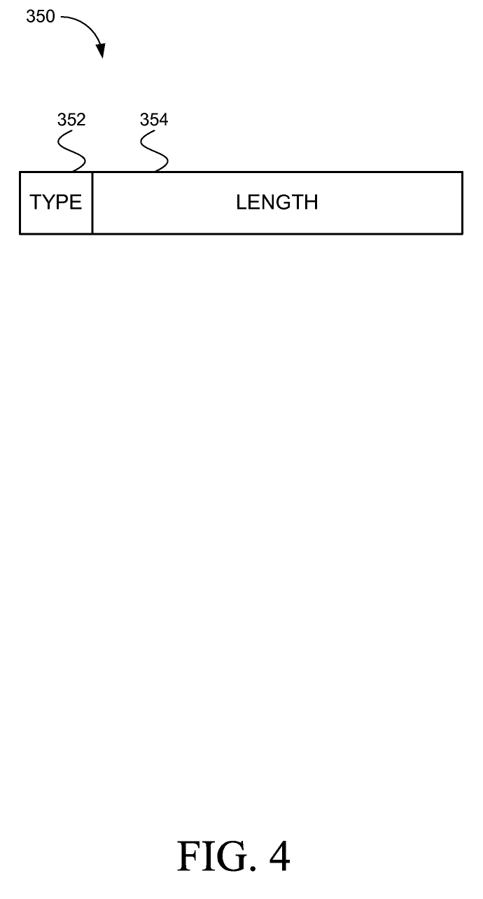

FIG. 4 is a schematic diagram showing an exemplary command packet 350 used for sending a heartbeat command on the secure channel. The command packet 350 may use a simple type-length-value (TLV) encoding scheme, with zero data. The command packet 350 may be 5 bytes in length, for example, with a first byte 352 assigned for the type, and 4 bytes 354 for the length (zero). The type may have two values for example: SECURE_HEART_BEAT and SECURE_HEART_BEAT_RESPONSE. The command packets are sent on the secure channel at an interval that may be specified by the user, a network administrator, or the manufacturer.

In some embodiments, any secure packet sent over the secure channel can be considered as a heartbeat command, for example, as the secure heartbeat or the response to the secure heartbeat. Sending such a secure packet in lieu of a secure heartbeat will restart the timer referred to in FIG. 3B and receiving such a secure packet in lieu of a secure heartbeat will restart the timer referred to in FIG. 3A. Similarly, receiving such a secure packet in lieu of a secure heartbeat response will stop the timer referred to in FIG. 3B. For example, while importing certificates, many secure packets are sent back and forth between smart card reader 102 and a protected device such as mobile device 104 or personal computer 106. These secure packets may be considered as secure heartbeat packets, even though they are of a different form. In such cases, there is no need to send additionally a heartbeat command of the form described in FIG. 4.

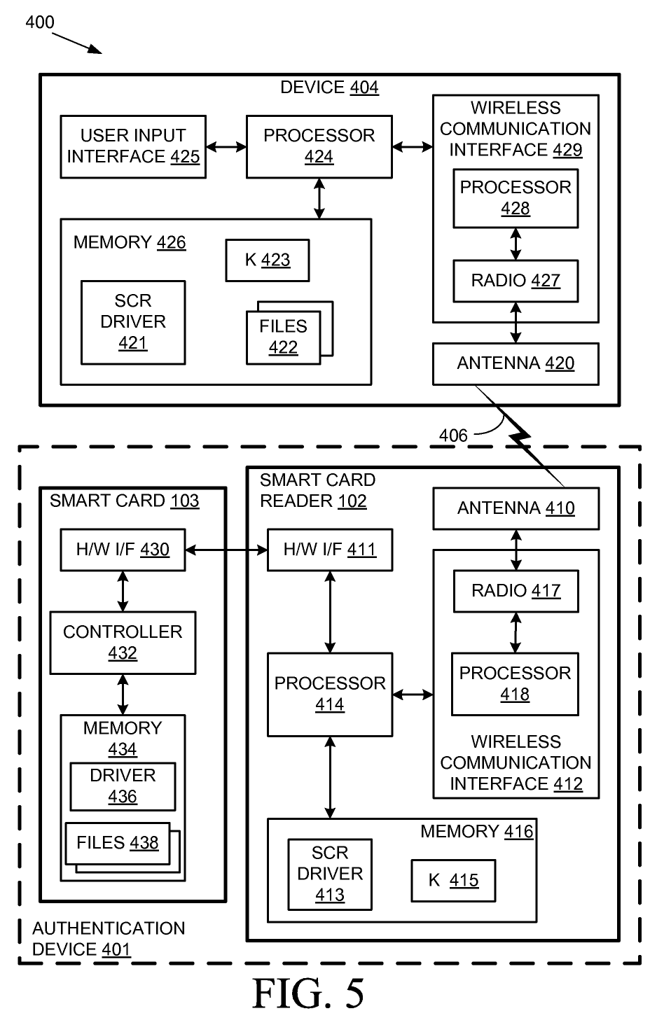

FIG. 5 is a block diagram of an exemplary system 400, according to some embodiments of the invention. System 400 includes a protected device 404 and an authentication device 401 that includes smart card reader 102 and smart card 103. Protected device 404 and smart card reader 102 are able to communicate over a wireless communication link 406, and smart card 103 is in direct communication with smart card reader 102. Personal computer 106 and mobile device 104 are examples of protected device 404.

Device 404 includes an antenna 420, a wireless communication interface 429, a processor 424 coupled to wireless communication interface 429, a memory 426 coupled to processor 424, and a user input interface 425 coupled to processor 424. Processor 424 and memory 426 may be part of the same integrated circuit or in separate integrated circuits. Wireless communication interface 429 includes a radio 427 coupled to antenna 420, and a processor 428 coupled to radio 427. Wireless communication interface 429 and processor 424 may be part of the same integrated circuit or in separate integrated circuits.

Memory 426 may be fixed in or removable from device 404. Memory 426 may be embedded or partially embedded in processor 424. Memory 426 may store executable code 421 which, when executed by processor 424, runs a smart card reader driver. Memory 426 may also store files 422 that correspond to confidential information. Memory 426 stores a key or keys 423 used for the advanced encryption on the secure channel.

Similarly, smart card reader 102 includes an antenna 410, a wireless communication interface 412 coupled to antenna 410, a processor 414 coupled to wireless communication interface 412, a hardware interface 411, and a memory 416 coupled to processor 414. For example, hardware interface 411 may be a connector that mates to a corresponding connector with contact pins on smart card 103. Memory 416 may be fixed in or removable from smart card reader 102. Memory 416 may be embedded or partially embedded in processor 414. Memory 416 stores executable code 413 that functions as a smart card reader driver when executed by processor 414. Memory 416 also stores a key or keys 415 used for the advanced encryption on the secure channel. Processor 414 and memory 416 may be part of the same integrated circuit or in separate integrated circuits. Wireless communication interface 412 comprises a radio 417 coupled to antenna 410, and a processor 418 coupled to radio 417. Wireless communication interface 412 and processor 414 may be part of the same integrated circuit or in separate integrated circuits. Communication interfaces 412 and 429 are compatible with Bluetooth® communication protocols and/or with other wireless communication standards, including for example, the Zigbee™ standard, the ultra wideband standard (UWB) and the like.

A non-exhaustive list of examples for antennae 410 and 420 includes dipole antennae, monopole antennae, multilayer ceramic antennae, planar inverted-F antennae, loop antennae, shot antennae, dual antennae, omnidirectional antennae and any other suitable antennae.

A non-exhaustive list of examples for processors 414, 418, 424 and 428 includes a central processing unit (CPU), a digital signal processor (DSP), a reduced instruction set computer (RISC), a complex instruction set computer (CISC) and the like. Furthermore, processors 414, 418, 424 and 428 may be part of application specific integrated circuits (ASICs) or may be a part of application specific standard products (ASSPs).

A non-exhaustive list of examples for memories 416 and 426 includes any combination of the following:

a) semiconductor devices such as registers, latches, read only memory (ROM), mask ROM, electrically erasable programmable read only memory devices (EEPROM), flash memory devices, non-volatile random access memory devices (NVRAM), synchronous dynamic random access memory (SDRAM) devices, RAMBUS dynamic random access memory (RDRAM) devices, double data rate (DDR) memory devices, static random access memory (SRAM), universal serial bus (USB) removable memory, and the like;

b) optical devices, such as compact disk read only memory (CD ROM), and the like; and

c) magnetic devices, such as a hard disk, a floppy disk, a magnetic tape, and the like.

Smart card 103 includes a hardware interface 430, a controller 432 coupled to hardware interface 430, and a memory 434 coupled to controller 432. Memory 434 stores executable code 436 which functions as a driver when executed by controller 432. Memory 434 also stores files 438 with confidential stored personal information about the smart card's owner.

Device 404, smart card reader 102 and smart card 103 include additional components which are not shown in FIG. 5 and which, for clarity, are not described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for short-range wireless communication in a first device, the method comprising:
establishing a short-range wireless connection with a second device;
imposing security measures on the wireless connection at the application level to create a secure channel; and
creating a secure keep-alive heartbeat on the secure channel.

2. The method of claim 1, wherein creating a secure keep-alive heartbeat on the secure channel comprises at least transmitting a query to the second device on the secure channel, and waiting for a response from the second device to the query.

3. The method of claim 1, further comprising:
dropping the wireless connection between the two devices if the secure keep-alive heartbeat is lost.

4. The method of claim 1, wherein imposing security measures at the application level comprises at least applying advanced encryption techniques to encrypt data transmitted on the secure channel.

5. The method of claim 4, further comprising:
dropping the wireless connection between the two devices if the secure keep-alive heartbeat is lost.

6. The method of claim 5, further comprising:
erasing any advanced encryption keys after the wireless connection is dropped.

7. The method of claim 6, further comprising:
waiting a predetermined time interval after the wireless connection is dropped before erasing said advanced encryption keys.

8. The method of claim 5, further comprising:
erasing any secrets used to generate advanced encryption keys after the wireless connection is dropped.

9. The method of claim 8, further comprising:
waiting a predetermined time interval after the wireless connection is dropped before erasing said secrets.

10. A computer-readable medium having computer-executable instructions which, when executed by a processor of a first wireless device, result in:
establishing a short-range wireless connection with a second device;
imposing security measures on the wireless connection at the application level to create a secure channel; and
creating a secure keep-alive heartbeat on the secure channel.

11. The computer-readable medium of claim 10, wherein the instructions, when executed by the processor, further result in:
dropping the wireless connection between the two devices if the secure keep-alive heartbeat is lost.

12. A first wireless device comprising:
a memory;
a processor coupled to the memory; and
a wireless communication interface coupled to the processor,
wherein the memory is able to store code which, when executed by the processor, is arranged to create a secure communications channel with a second device for a short-range wireless communication session and is arranged to create a secure keep-alive heartbeat on the secure channel.

13. The first device of claim 12, wherein the device contains smart card reader functionality.

14. The first device of claim 12, wherein the memory is able to store code which, when executed by the processor, is arranged to delete pairing keys if the secure keep-alive heartbeat is lost.

15. The first device of claim 12, wherein the memory is able to store code which, when executed by the processor, is arranged to delete shared secrets if the secure keep-alive heartbeat is lost.

16. A system for short-range wireless communication, comprising:
a first wireless-enabled device; and
a second wireless-enabled device able to communicate wirelessly with the first device,
wherein the first device and the second device are arranged to create a secure communications channel therebetween at the application level for a wireless communication session, and
wherein the first device is arranged to create a secure keep-alive heartbeat on the secure channel.

17. The system of claim 16, wherein the first device is arranged to transmit a query to the second device on the secure channel and to wait for a response from the second device to the query.

18. The system of claim 16, wherein one or both of the first device and the second device is arranged to drop the wireless communication session if the secure keep-alive heartbeat is lost.
